(19) United States
(12) Patent Application Publication
(10) Pub. No.: US 2007/0299822 A1
(43) Pub. Date: Dec. 27, 2007

(54) Database connectivity

(75) Inventors: John Jopp, Kannapolis, NC (US); Felix Ammay, Kings Mountain, NC (US); Aaron D. Harrell, Charlotte, NC (US); Jackie E. Walker, Charlotte, NC (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation

(21) Appl. No.: 11/474,854

(22) Filed: Jun. 26, 2006

(51) Int. Cl. G06F 17/30

(52) U.S. Cl. 707/3

(57) ABSTRACT

Database connectivity without a need for installing database specific drivers on individual client machines/applications is provided. A database access application module resides on a server associated with the database(s) to be accessed. User interface modules residing on individual client machines/applications enable users to submit their queries or select from a set of predefined queries through the database access application module and receive result sets. Available databases and their properties are updated by the database access application module preventing delays and errors without a need to update database information on individual clients.

### TECHNICAL FIELD

Embodiments are related to database connectivity in a networked environment. More particularly, the disclosed subject matter is related to computer-implemented methods, configurations, systems, and computer program products for connecting to a database using a query language such as Sequential Query Language (SQL) without a need for Open Database Connectivity (ODBC) drivers.

### BACKGROUND

ODBC offers a procedural Application Programming Interface (API) for using queries, such as SQL, to access data in an open database. An implementation of ODBC may contain one or more applications, a core ODBC library, and one or more “database drivers”. The core library, independent of the applications and database management system, acts as an “interpreter” between the applications and the database drivers, whereas the database drivers contain the database management system specific details. Thus a programmer can write applications that use standard types and features without concern for the specifics of each database management system that the applications may encounter. Likewise, database driver implementors need only know how to attach to the core library. This makes ODBC modular.

To write ODBC code that exploits DBMS-specific features requires more advanced programming. An application may have to call ODBC metadata functions that return information about supported features, available types, syntax, limits, isolation levels, driver capabilities, and more.

ODBC provides a standard of ubiquitous data access because a large number of ODBC drivers exist for a large variety of data sources. ODBC is available for a variety of operating systems and there are drivers for non-relational data such as spreadsheets, text and XML files. Despite the benefits of ubiquitous connectivity and platform independence, ODBC has certain drawbacks. Administering a large number of client machines may involve a diversity of drivers and Dynamic Link Libraries (DLLs). This complexity may increase system administration overhead.

The layered architecture of ODBC can also introduce a performance penalty. The overhead of executing an additional layer of code may appear insignificant compared to network latency and other factors that influence query performance. Driver architecture is also a consideration. Many first-generation ODBC drivers operated with database client libraries supplied by a database management system vendor. The newer type of driver may communicate without needing database client libraries.

### SUMMARY

Consistent with embodiments described herein, systems and methods are disclosed for providing database access through a client-installed user interface module communicating with a server application module maintaining database specific information. Key features or essential features of the claimed subject matter are not necessarily identified in this summary portion.

Embodiments are directed to a user interface module and a server application module that are configured to execute a user provided query on at least one selected database without having to install a database specific driver on a client device or application utilized by the user. The user interface module may be configured to enable the user to select from a list of predefined queries or from a list of previously submitted queries in addition to entering a user-defined query.

According to some embodiments, the server application module may validate the submitted query, confirm a user credential, execute the submitted query on a plurality of databases, or maintain an updated list of database properties for executing the queries.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

FIG. 1 is a block diagram of an example computing operating environment;

FIG. 2 illustrates a networked system where example embodiments may be implemented;

FIG. 3 illustrates an example database system with ODBC drivers installed on individual client machines;

FIG. 4 illustrates an example database system according to embodiments, where a database access application module provides access to the database for users without having to install ODBC drivers on individual client machines;

FIG. 5 illustrates a conceptual diagram of a database access system according to embodiments; and

FIG. 6 illustrates a logic flow diagram for a process of accessing a database using a database access application module according to one embodiment.

### DETAILED DESCRIPTION

As briefly described above, a database access application module enables users to access databases using a client interface without a need for installing database specific drivers. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

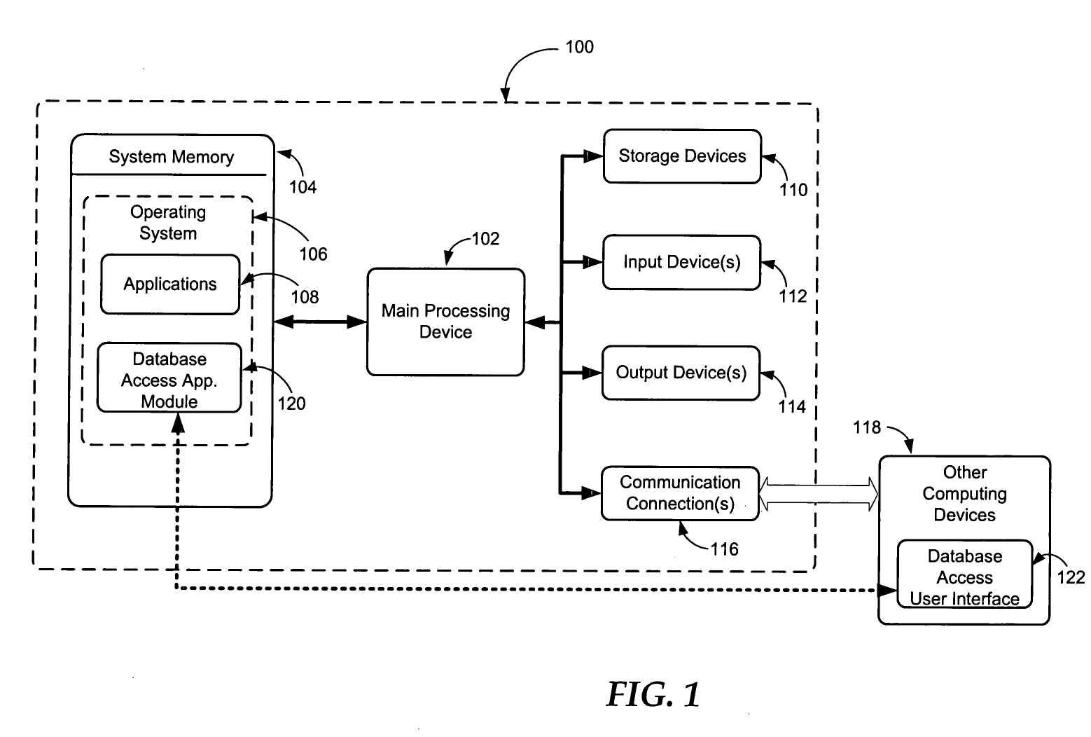

Referring now to the drawings, aspects and an exemplary operating environment will be described. FIG. 1 and the following discussion are intended to provide a brief, general description of a suitable computing environment in which the invention may be implemented. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, one example system for implementing the embodiments includes a computing device, such as computing device 100. Computing device 100 typically includes a main processing unit 102 and system memory 104. The system memory 104 may be volatile (such as RAM), non-volatile (such as ROM, flash memory, etc.) or some combination of the two. System memory 104 typically provides an environment for an operating system 106 to be executed for controlling the operation of computing device 100 and execution of other programs (applications). Software applications 108 such as program modules and database access application module 120 are examples of programs or program modules that may be executed under the control of operating system 106 in system memory 104. Additional operating systems or programs may also be executed within system memory 104 outside the control of operating system 106. Database access application module 120 enables a user to access a database and submit queries using a user interface at his/her local machine without a need for installing database specific drivers.

Database access application module 120 may be an integrated part of a database management application or a separate application. Database access application module 120 may communicate with other applications running on computing device 100 or on other devices. For example, database access application module 120 may communicate with database access user interface 122 residing on other computing device 118, where a user may submit his/her own query or select from a set of predefined queries. Database access application module 120 then performs actions associated with submitting the query to the selected database and return results to the user. Other features of database access application module 120 according to embodiments are described in more detail below. Furthermore, database access application module 120 may be executed in an operating system other than operating system 106.

The computing device 100 may have additional features or functionality. For example, the computing device 100 may also include data storage devices 110 (removable and/or non-removable) such as, for example, magnetic disks, optical disks, or tape. Computer storage media may include volatile and nonvolatile, removable and non-removable media implemented in any method or technology for storage of information, such as computer readable instructions, data structures, program modules, or other data. System memory 104 and storage devices 110 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100.

Computing device 100 may also include input device(s) 112 such as a keyboard, a mouse, a pen, a voice input device, a touch input device, etc. Furthermore, output device(s) 114 such as a display, a speaker, a printer, etc. may also be included. These devices are well known in the art.

Communication connections 116 may be included in computing device 100 to allow the device to communicate with other computing devices 118, such as over a network in a distributed computing environment, for example, an intranet or the Internet. Communication connection 116 exemplifies various communication media. Communication media may be embodied by computer readable instructions, data structures, program modules, or other data in a modulated data signal, such as a carrier wave or other transport mechanism, and include any information delivery media.

By way of example, and not limitation, communication media may include wired media such as a wired network or direct-wired connection, and wireless media such as acoustic, RF, infrared and other wireless media. The term computer readable media as used herein refers to both storage media and communication media.

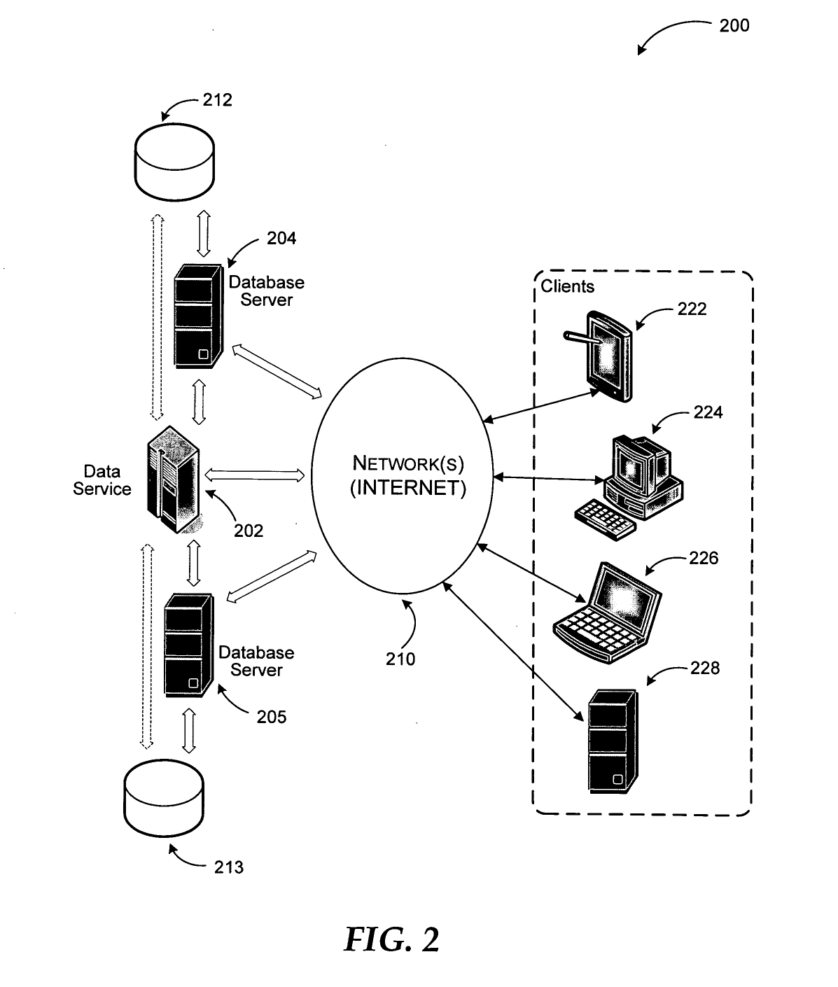

Referring to FIG. 2, a networked system 200 where example embodiments may be implemented is illustrated. System 200 may comprise any topology of servers, clients, Internet service providers, and communication media. Also, system 200 may have a static or dynamic topology. The term “client” may refer to a client application or a client device employed by a user to perform database access operations. Data service 202 may be one or more programs or a server machine executing programs associated with the server tasks. Both clients and application servers may be embodied as single device (or program) or a number of devices (programs). Similarly, data sources may include one or more data stores, input devices, and the like.

Data service 202 may operate in conjunction with several database servers, e.g. 204, 205, or may be operated in a distributed manner over several servers and/or client devices. Data service 202 may include implementation of a number of data management systems such as data storage, data refreshing, data maintenance scheduling, and the like, in addition to database access application module 120 which enables a user to access a database and submit queries using a user interface at his/her local machine without a need for installing database specific drivers. Data service 202 may also execute multiple versions or instantiations of database access application module 120 according to some embodiments. As explained above, this module may interact with user interface modules on individual clients, e.g. client devices 222, 224, 226, and 228, through network 210 and receive user submitted queries, which are then forwarded to available databases, e.g. databases 212, 213. Result sets from the databases may then be returned to the requesting clients. A number of other applications may also be configured, deployed, and shared in system 200.

Network(s) 210 may include one or more secure networks such as an enterprise network, unsecure networks such as a wireless open network, or the Internet. Network(s) 210 provide communication between the nodes described above. By way of example, and not limitation, network(s) 210 may include wired media such as a wired network or direct-wired connection, and wireless media such as acoustic, RF, infrared and other wireless media. Many other configurations of computing devices, applications, and data storage may be employed to implement a database access system according to embodiments.

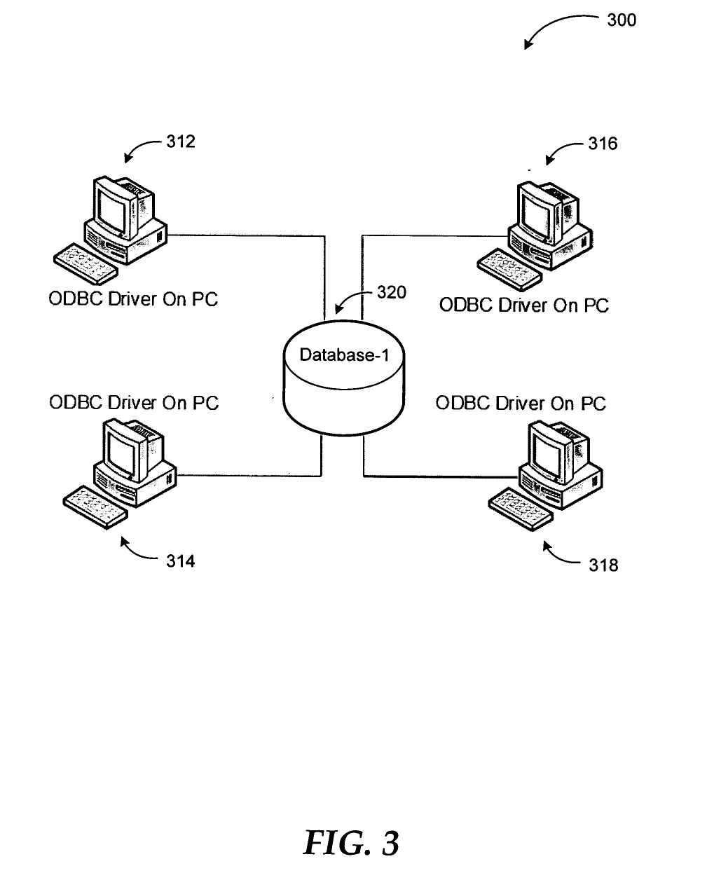

Now referring to FIG. 3, an example database system 300 with ODBC drivers installed on individual client machines is illustrated. Database system 300 may comprise any topology of processing systems, storage systems, source systems, and configuration systems. Database system 300 may also have a static or dynamic topology.

At the core of database system 300 are one or more databases, e.g. database 320. Typically, multiple users access database 320 from individual client machines or applications on client machines, e.g. PC's 312, 314, 316, and 318. In an ODBC environment, each user machine (virtual or physical) may require a separate driver for each database that is to be accessed. The system 300 commonly includes a core library that acts as an “interpreter” between the applications and the database drivers, where the core library is independent of applications and database management system. The database drivers contain database management system specific details.

While having database specific drivers reside on individual machines provides speedy access to the databases. However, in a dynamic system where users may desire to access the database(s) from different machines at different times and a number of available databases or properties of the available databases may vary over time, easy and efficient access may be problematic. Drivers may have to be installed for each new machine or for each user depending on security setup of the machines. Moreover, drivers may have to be updated each time a new database becomes available or properties of a database such as their structure are modified. Furthermore, keeping track of available databases in real time may also be a challenge.

Embodiments provide a modular system that enables user access to available databases without a need to install drivers on each machine utilized by a user and eliminates the need to update database specific information on the user machines.

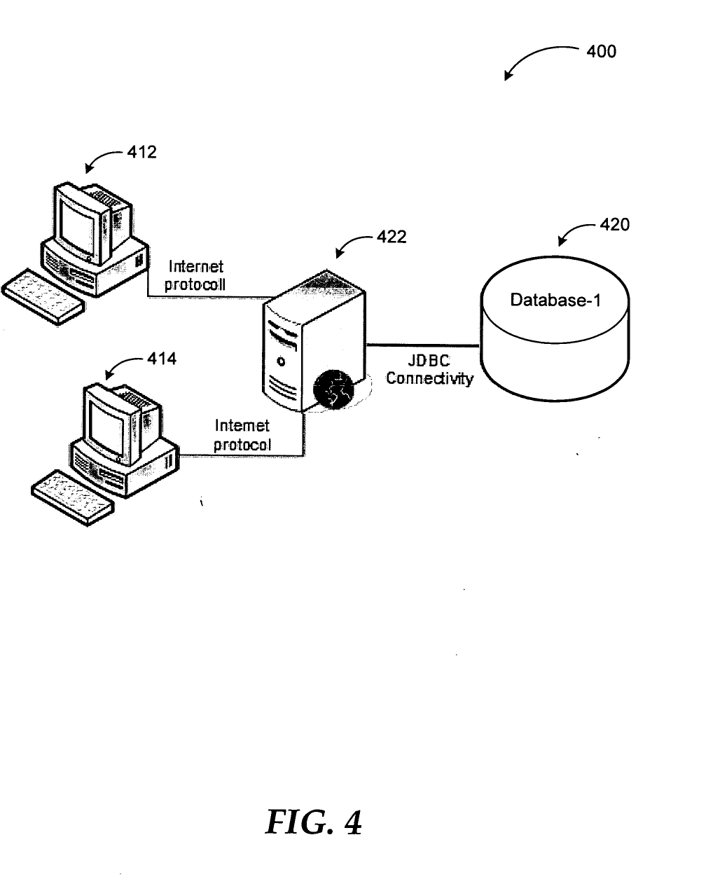

FIG. 4 illustrates an example database system 400 according to embodiments, where a database access application module provides access to the database for users without having to install ODBC drivers on individual client machines. In database system 400 according to some embodiments, the database connectivity is configured on server 422 such that individual users do not have to go through a complicated setup. A user interface module (e.g. a WINDOWS® interface), which is relatively simple to install and may require limited system resources, is installed on individual user machines e.g. 412, and 414. User interfaces can communicate with a database access application module on server 422 through any communication protocol such as Internet Protocol (IP). Because the database access application module 120 handles communication with the database(s), e.g. database 420, individual users can have immediate access to all available databases. Moreover, any table structure changes may be refreshed immediately to the database access application module 120 since it retrieves database information on the fly each time a database is selected. This eliminates a need to update database specific information on the user machines 412 and 414. In addition, any time a new database is added to the database access application module 120, it may be made available to all users the without any manual intervention.

According to some embodiments, the database access application module 120 may be implemented as a servlet enabling web developers or database administrators simplified access and querying capability of various database types without the installation of ODBC drivers. In a specific example using Internet protocol, the module 120 may be implemented as a JAVA® servlet that uses Java Database Connectivity (JDBC) to facilitate database connections and query functions. In the example embodiment, the initial setup may require access to a web server and JAVA® programming knowledge to setup and run the JAVA® servlet.

Once the database access servlet is configured with database information and deployed, any user can install the user interface and access the configured databases without the need of complicated and lengthy ODBC driver configuration process. The user interface may provide additional services such as selection from a list of predefined queries, user credential based filtering, a history of submitted queries, and the like.

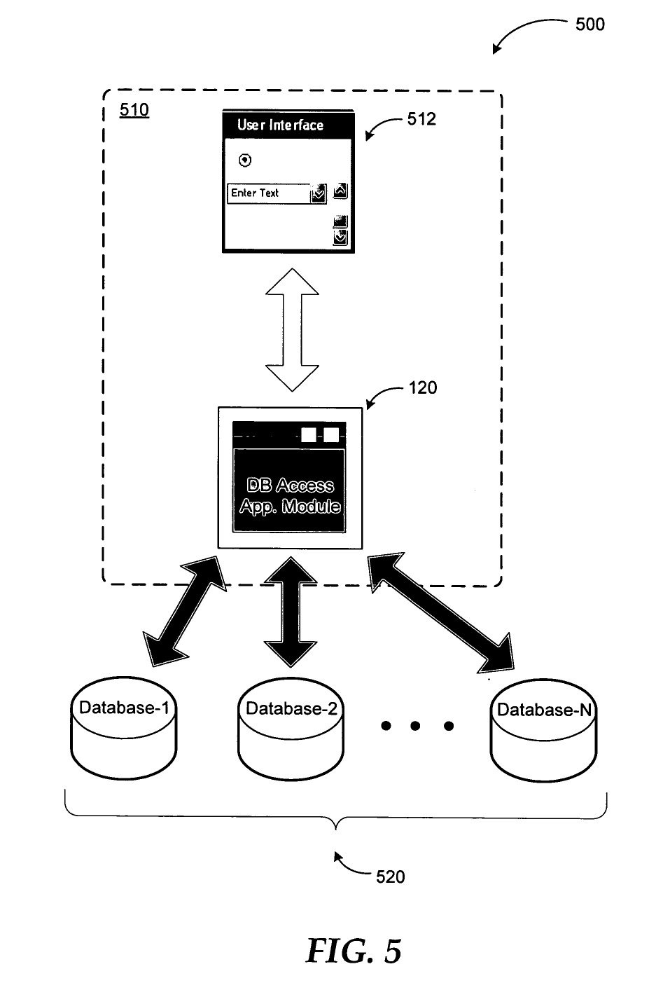

FIG. 5 illustrates conceptual diagram 500 of a database access system according to embodiments. Conceptual diagram 500 includes database access system 510 comprising user interface 512 and database access application module 120. User interface 512 may be provided by a relatively simple module such as a WINDOWS® interface module. Database access application module 120 may be a database access application module residing on a server associated with the databases to be accessed. As described previously, database access application module 120 may be a JAVA® servlet in an Internet connectivity environment.

Database access application module 120 is configured to access databases 520, translate and submit queries from user interface 512 to the databases 520, and return result sets to the user interface 512. In a typical implementation, database access application module 120 may reside on a web server with multiple user interfaces residing on individual client devices. Other configurations of the two elements, such as both residing on the same computing device, may also be implemented using the principles described herein.

In addition to providing user defined queries to the database access application module 120, the user interface may also provide users with a list of predefined queries for users who perform periodic data collection with similar parameters. One or both of user interface 512 and database access application module 120 may include a user credential based filtering service, where access to selected databases or types of queries that may be executed may be restricted based on a user's credentials. Additional services provided by the database access application module 120 may include scheduling and optimization of queries for efficient use of system resources, maintaining a history of executed queries, validation of queries, and the like.

According to other embodiments, database access application module 120 may be configured to make any new database that has been requested by one user to other users. Changes to available databases, such as structure changes, may be updated at the database access application module 120 eliminating the need to update database specific information in each user machine (or application).

The database access application module 120 and user interfaces discussed in conjunction with FIGS. 2-5 are example embodiments. The invention is not limited to these implementations, however. Other embodiments such applications, program modules, scripts, and the like may be implemented using the principles described herein.

Furthermore, the example implementation environments of database access systems shown in FIGS. 2-5 are intended for illustration purposes only and should not be construed as a limitation on embodiments. Other embodiments may be implemented without departing from a scope and spirit of the invention.

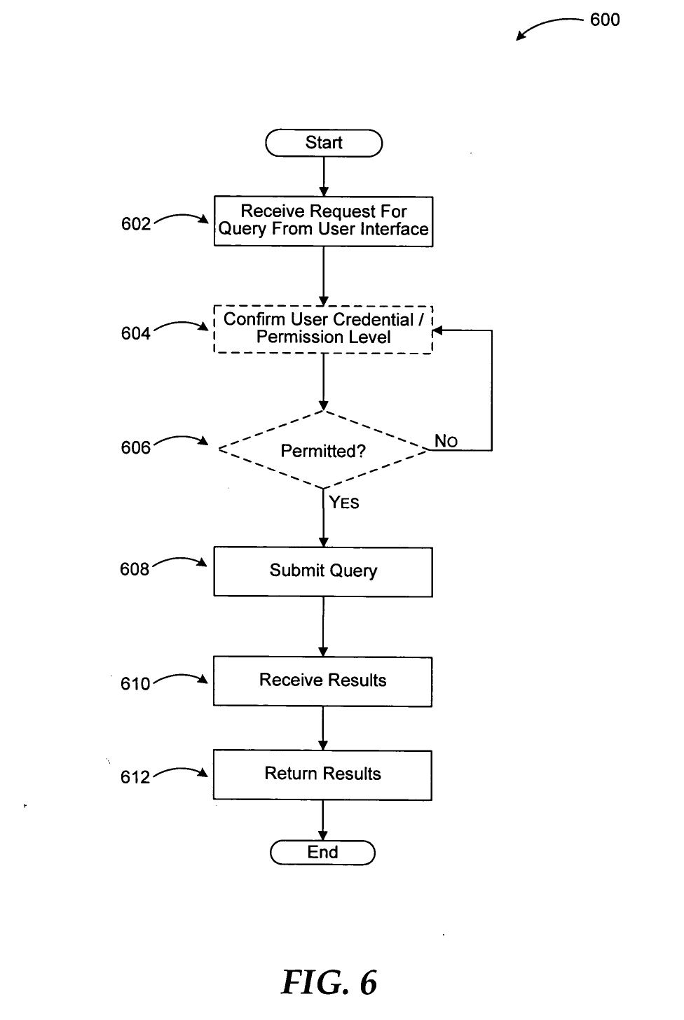

FIG. 6 illustrates a logic flow diagram 600 for a process of accessing a database using a database access application module 120 according to one embodiment. Process 600 may be implemented in a database access application module such as database access application module 120 of FIG. 5.

Process 600 begins with operation 602, where the database access application module 120 receives a request for a query from a user interface. In some embodiments, the request for query may include the query itself. In other embodiments, the user interface may first request permission to submit a query and send the query once one or more conditions, such as the availability of the requested database, are confirmed. Processing moves from operation 602 to optional operation 604.

At optional operation 604, the database access application module 120 confirms a user credential or permission level. As mentioned above other conditions such as availability of database, system resources, and the like, may also be confirmed (not shown). Processing advances from optional operation 604 to optional decision operation 606.

At optional decision operation 606, the database access application module 120 determines whether the user is permitted to query the requested database. If the user is not permitted, processing returns to operation 604. If the user is permitted, processing advances to operation 608.

At operation 608 the database access application module 120 submits the query to the selected database(s). According to some embodiments, database access application module 120 managing the database access may coordinate execution of the query on multiple databases. Processing moves from operation 608 to operation 610.

At operation 610, the database access application module 120 receives one or more result sets from the database(s). Processing moves from operation 610 to operation 612.

At operation 612, the database access application module 120 returns the received result set(s) to the requesting user interface module for presentation to the user. After operation 612, processing moves to a calling process for further actions.

The operations included in process 600 are for illustration purposes. Accessing a database without installing database specific drivers on user machines and/or applications may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for accessing a database, comprising:
receiving a query at a server application module that is installed at a server associated with the database, wherein the server maintains database specific information, and wherein the query is provided by a user interface module independent of the database;
submitting the query to the database from the server; and
providing a result set associated with the query to the user interface module from the server application module.

2. The method of claim 1, wherein receiving the query includes one of:
receiving a user prepared query; and
receiving one of a predefined set of queries based on a user selection.

3. The method of claim 1, further comprising:
receiving a user credential; and
submitting the query to the database upon confirming a validity of the user credential.

4. The method of claim 1, wherein the user interface module is installed at one of: a client application and a client device.

5. The method of claim 1, wherein the server is one of: a server application and a server machine.

6. The method of claim 1, wherein the server is a web server.

7. The method of claim 1, further comprising:
validating the received query before submitting to the database.

8. The method of claim 1, further comprising:
maintaining a history of submitted queries such that the user may reuse a previously submitted query.

9. The method of claim 1, further comprising:
translating the received query based on database specific properties.

10. The method of claim 1, further comprising:
executing the received query on a plurality of databases.

11. The method of claim 1, further comprising:
receiving database specific property information from the database upon receiving the query; and
making the database available for querying to at least one additional user.

12. The method of claim 11, further comprising:
updating the database specific property information anytime a query is received from a user associated with the database.

13. A system for accessing a database, comprising:
a user interface module installed on a client device arranged to:
enable a user to provide a query for the database by one of: selecting from a predefined set of queries and entering a user-defined query;
submit the query to a server application module; and
the server application module arranged to:
receive the submitted query from the user interface module;
execute the query on the database; and
return a result set received from the database in response to the executed query to the user interface module.

14. The system of claim 13, wherein the server application module is further arranged to:
determine the database based on the received query; and
receive a database specific property upon determining the database.

15. The system of claim 14, wherein the server application module is further arranged to:
confirm a user credential; and
validate the query based on the database specific property before executing the query.

16. The system of claim 14, wherein the server application module is further arranged to:
update the database specific property at a predetermined period; and
make the database available for querying to at least one additional user.

17. The system of claim 13, wherein the user interface module is further arranged to:
activate an application to consume the received result set.

18. A computer-readable medium having computer executable instructions for accessing a database, the instructions comprising:
enabling a user to provide a query directed to the database using a user interface module that is installed at a client device associated with the user without having a database specific driver installed at the client device;
receiving the query at a server application module that is installed at a web server associated with the database, wherein the server maintains database specific information;
submitting the query to the database from the server application module; and
providing a result set associated with the query to the user interface module from the server application module.

19. The computer-readable medium of claim 18, wherein the instructions further comprise:
modifying the query at the server application module based on at least one of: a user credential, a database property, and a system resource availability.

20. The computer-readable medium of claim 18, wherein the instructions further comprise:
providing the user one of: a predefined set of queries and a list of previously submitted queries to select from.
